(19) United States
(12) Patent Application Publication
(10) Pub. No.: US 2004/0172288 A1
(43) Pub. Date: Sep. 2, 2004

(54) Method for disseminating medical alert information

(76) Inventor: Lawrence D. Korn, Farmington Hills, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/375,447

(22) Filed: Feb. 27, 2003

(51) Int. Cl. G06F 11/30; G06F 17/60; G06F 15/00; G21C 17/00

(52) U.S. Cl. 705/2

(57) ABSTRACT

A method for disseminating alert information regarding medical procedures in which medical episode reports are sent by medical providers describing medical episodes of patients involving the medical provider to a central processing location. Each episode report is redacted to delete all information which identifies either the patient and/or the medical provider. The redacted reports are then processed to generate a synopsis of the medical episode and that synopsis is then sent to a plurality of other medical providers over the World Wide Web.

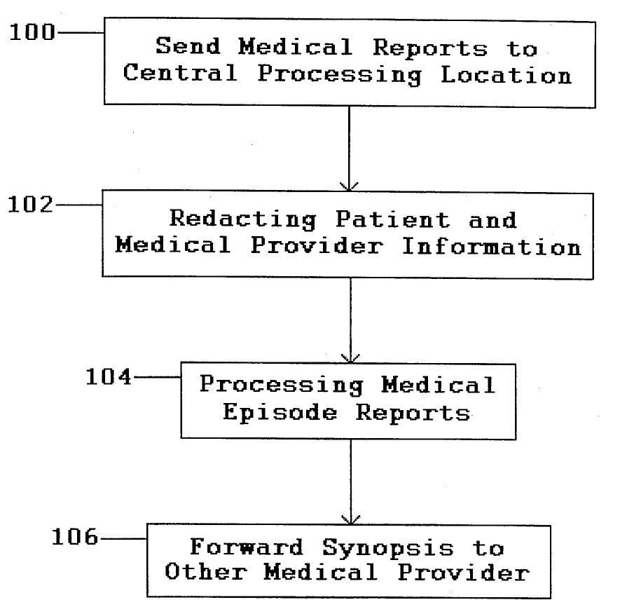

### BACKGROUND OF THE INVENTION

I. Field of the Invention

The present invention relates to a method for disseminating medical alert information.

II. Description of the Prior Art

Medical episodes resulting in potential injury, actual injury or even death to patients frequently occur at medical providers, such as hospitals, doctors' offices and the like. These medical episodes, at times, involve questionable decisions made by the medical provider and/or unexpected consequences resulting from the medical procedures and/or medication utilized by the medical provider for a particular patient. Such episodes include morbidity reports, mortality reports, as well as medical events in which the patient is subjected to a medical crisis but the medical provider was unable to successfully treat the patient and avoid injury to the patient.

In order to defend against possible legal consequences resulting from the medical episode, many if not most medical providers maintain not only the identification of the medical episode, but all of the medical procedures and personnel involved in the medical episode in great secrecy. This process unfortunately limits the dissemination of the medical procedures which resulted in the medical episode and the resulting. harm to the patient. If such information were widely disseminated, other medical providers may be able to prevent the reoccurrence of a similar medical episode at that particular medical provider.

### SUMMARY OF THE PRESENT INVENTION

The present invention provides a method for disseminating medical alert episode information which overcomes all of the above-mentioned disadvantages of the previously known procedures.

In brief, all information regarding the medical episode report, including the medical procedures performed, medication provided, etc., are provided to a central processing location. This central processing location may be located outside U.S. jurisdiction to preclude disclosure of the information through U.S. legal process. Preferably, the medical episode reports are transmitted via the World Wide Web.

All of the medical episode reports are redacted to delete all information regarding both the patient as well as the medical provider. The medical provider providing the report to the central processing location may redact the information prior to its transmission to the central processing location or, alternatively, such redaction may occur at the central processing location itself.

Thereafter, a synopsis of each medical episode report is performed at the central processing location. That synopsis does not contain any information which identifies either the patient or the medical provider involved in the medical episode.

Thereafter, the synopsis of the medical episode is provided to a plurality of other medical providers, preferably electronically over the World Wide Web. By providing the synopsis to the other medical providers, other medical providers facing the same set of medical circumstances would be able to avoid the procedures set forth in the synopsis and likewise prevent harm to future patients. Preferably, these medical providers pay a subscription fee to receive the synopses of the medical episodes from other medical providers.

### BRIEF DESCRIPTION OF THE DRAWING

A better understanding of the present invention will be had upon reference to the following detailed description, when read in conjunction with the accompanying drawing, which is a flowchart diagrammatically depicting the preferred method of the present invention.

### DETAILED DESCRIPTION OF A PREFERRED EMBODIMENT OF THE PRESENT INVENTION

With reference to the drawing, whenever a medical episode occurs at a medical provider, the medical provider prepares a medical episode report and transmits that medical episode report to a central processing location as shown at step 100. The medical providers would typically comprise hospitals, doctor offices and other medical care providers. Furthermore, a medical episode occurs whenever a patient is harmed, or might have been harmed but for a timely intervention by the medical provider, through medical treatment by the medical provider. Such harm can result not only from questionable medical decisions made by the medical provider in treating the patient, but also results when a patient responds in an unexpected fashion to a particular medical procedure, medication or the like. The medical episode report itself contains all of the information regarding not only medical information relating to the condition of the patient, but also the procedures, medications, and the like performed by the medical provider for the patient and which resulted in the medical episode.

At step 102, each medical episode report is redacted to delete all information that can identify either the patient involved in the medical episode, or the medical provider providing the medical treatment which resulted in the medical episode. The redaction of the identification information for both the patient and the medical provider may be provided either by the medical provider prior to sending the medical episode report to the central processing location, or may be preformed at the central processing location itself. In either event, the redacted medical episode report sets forth a full explanation of the medical condition of the patient, medical procedures, medications and the like provided to the patient as well as the harm resulting to the patient.

Preferably the central processing location is situated outside of U.S. legal jurisdiction. As such, the central processing location would not be subject to legal process from U.S. courts. Additionally, in order to expedite the transmission of the episode reports from the medical providers and to the central processing location, preferably such reports are transmitted over the World Wide Web.

At step 104 the central processing location processes the medical episode reports to generate a synopsis of the medical episode report. That synopsis of the report may be the initial report from the medical provider, but may also include other additional information such as a proposed medical procedure which would avoid or at least minimize harm to a patient under similar medical conditions.

At step 106, the central processing location then forwards the prepared synopsis of each medical episode report to a plurality of other medical providers, preferably over the World Wide Web. These medical providers preferably pay a subscription fee to receive the synopses of the reports from the central processing location which enables the central processing location to pay for both the personnel and equipment necessary to operate the central processing location.

By providing the synopses of the medical episodes to a plurality of medical providers, these other medical providers will be able to avoid the medical procedures which resulted in harm to the patient when treating patients under similar medical procedures at each medical provider.

From the foregoing, it can be seen that the present invention achieves the dissemination of medical information to alert medical providers to avoid certain medical procedures, medication and the like for their own patients that are under similar medical conditions as the patient involved in the individual medical episode report. Furthermore, since the synopsis of each medical episode that is provided to the medical providers is done so anonymously, i.e. without identification of either the patient or the medical provider involved, medical providers will freely provide medical episode reports without fear of legal ramifications.

Having described my invention, however, many modifications thereto will become apparent to those skilled in the art to which it pertains without deviation from the spirit of the invention as defined by the scope of the appended claims.

I claim:

1. A method for disseminating alert information regarding medical procedures comprising the steps of:
sending medical episode reports from medical providers describing medical episodes of patient(s) involving the medical provider to a central processing location,
redacting said episode reports to delete all information which identifies either the patient(s) and/or the medical provider, and
processing said redacted reports to generate a synopsis of the medical episode report,
forwarding the synopsis to a plurality of other medical providers.

2. The invention as defined in claim 1 wherein said forwarding step further comprises the step of forwarding said synopsis electronically via the World Wide Web.

3. The invention as defined in claim 1 wherein said sending step further comprises the step of sending said medical episode reports electronically via the World Wide Web.

4. The invention as defined in claim 1 wherein said processing step comprises the step of formulating a medical recommendation as a part of said synopsis.

5. The invention as defined in claim 1 and comprising the step of charging a subscription fee from said other medical providers.

6. The invention as defined in claim 1 wherein said central processing location is outside of the United States.
